(19) United States
(12) Patent Application Publication
(10) Pub. No.: US 2005/0051475 A1
(43) Pub. Date: Mar. 10, 2005

(54) Nonwoven-fabric-type oil filter integral to a valve body

(76) Inventor: Ki Hyup Kim, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,658

(22) Filed: Dec. 31, 2003

(30) Foreign Application Priority Data
Sep. 5, 2003 (KR) 10-2003-0062122

(51) Int. Cl. B01D 35/00

(52) U.S. Cl. 210/435; 210/450; 137/544

(57) ABSTRACT

A nonwoven-fabric-type oil filter, integral to a valve body, includes a first cover member mounted to an open side of the valve body and has a first cover, a second cover and a nonwoven fabric oil filter therebetween. The first cover member has at least one first oil hole for allowing oil flow therethrough. The second cover member is conjoined with the first cover member and has at least one second oil hole. The nonwoven fabric oil filter is disposed between the first and second cover members for filtering oil flowing from the valve body into a hollow portion therebetween.

### CROSS-REFERENCE TO RELATED APPLICATIONS

This application claims priority of Korean Application No. 10-2003-0062122, filed on Sep. 5, 2003.

### FIELD OF THE INVENTION

Generally, the present invention relates to a nonwoven-fabric-type oil filter integral to a valve body. More particularly, the present invention relates to a nonwoven-fabric-type oil filter integral to a valve body having enhanced degrees of freedom in designing, durability, and filtering capability.

### BACKGROUND OF THE INVENTION

Owing to long durability and high filtering capability of a nonwoven fabric, a nonwoven-fabric-type filter is widely used for automatic transmissions and continuously variable transmissions.

According to the prior art, a nonwoven-fabric-type oil filter is typically mounted to a connection formed at a side of a valve body. T nonwoven fabric is contained in a cover member in a longitudinal direction thereof. An oil hole is formed in the cover member. Such a structured nonwoven-fabric-type oil filter generally shows good filtering efficiency and durability, but it consumes mounting volume since the valve body and the nonwoven-fabric-type oil filter have a gap therebetween.

In another prior art filter, a mesh-type oil filter is mounted to a valve body having an open side. Such a mesh-type oil filter is typically net structured with a steel material. This type of filter does not form a gap with the valve body, so the problem of mounting volume experience with the nonwoven-fabric-type oil filter is lessened.

However, a continuously variable transmission that uses hydraulic pressure at 2˜4 times higher than an automatic transmission requires a greater purity of oil. Therefore, when the mesh-type oil filter is used for a continuously variable transmission, due to lack of durability and filtering capacity thereof, an additional filter is required at a separate position for filtering impurities.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

Embodiments of the present invention provide a nonwoven-fabric-type oil filter integral to a valve body having non-limiting advantages of enhanced degrees of freedom in designing, durability, and filtering capability.

An exemplary nonwoven-fabric-type oil filter integral to a valve body according to an embodiment of the present invention includes:
a first cover member mounted to an open side of the valve body, the first cover member having at least one first oil hole for allowing oil flow therethrough, the first cover member being in close contact with the valve body;
a second cover member conjoined with the first cover member, the second cover member having at least one second oil hole; and
a nonwoven fabric oil filter disposed between the first and second cover members, for filtering oil flowing from the valve body into a hollow portion.

The hollow portion may be formed between the first and second cover members, and the nonwoven fabric oil filter is disposed in the hollow portion between the first and second cover members.

In a further embodiment, the at least one first oil hole is planarly provided as a plurality.

In another further embodiment, a gasket is interposed between the first cover member and the valve body such that oil leakage therefrom is prevented.

In a yet further embodiment, the first and second cover members are bolt-engaged to the valve body.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a plane view of a nonwoven-fabric-type oil filter integral to a valve body according to an embodiment of the present invention;

FIG. 2 is a bottom view of FIG. 1;

FIG. 3 is a sectional view of FIG. 1 along a line A-A; and

FIG. 4 illustrates an oil filter of FIG. 1 mounted to a valve body according to an embodiment of the present invention.

### DETAILED DESCRIPTION OF THE PREFERRED EMBODIMENTS

An embodiment of the present invention will hereinafter be described in detail with reference to the accompanying drawings.

The present invention is not limited to an embodiment described hereinafter, and may be realized in a variety of fashions. The present embodiment is only provided to fully describe the present invention and to fully convey the scope of the present invention to a person of ordinary skill in the art.

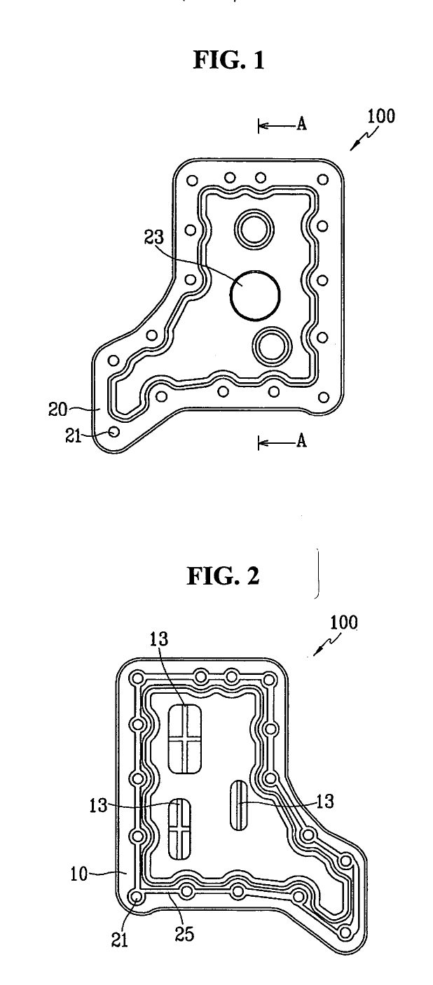

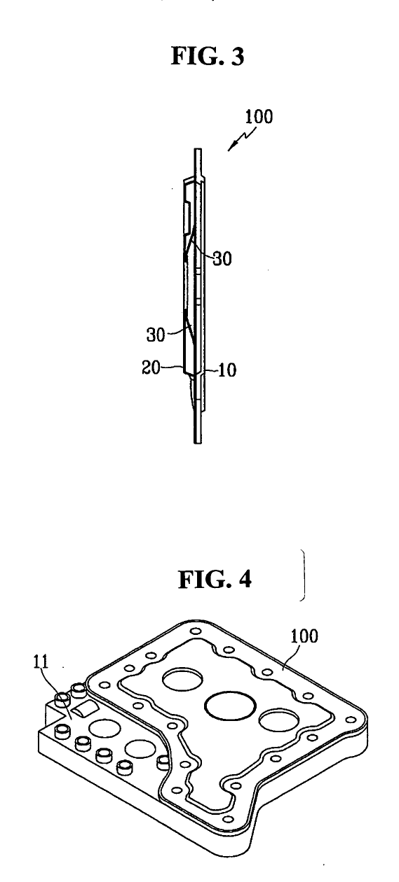

As shown in FIGS. 1-4, a nonwoven-fabric-type oil filter 100 integral to a valve body according to an embodiment of the present invention includes a first cover member 10, a second cover member 20, and a nonwoven fabric oil filter 30.

The first cover member 10 is mounted to an open side of the valve body 11, wherein the first cover member 10 has at least one first oil hole 13 for allowing oil flow therethrough, and the first cover member 10 is in close contact with the valve body 11.

The second cover member 20 is conjoined with the first cover member 10, and the second cover member 20 has at least one second oil hole 23.

The nonwoven fabric oil filter 30 is disposed between the first and second cover members 10 and 20, and filters oil flowing from the valve body 11.

The first cover member 10 is mounted to an open side of the valve body 11, and preferably, it is bolt-engaged therewith. The valve body 11 has an open side such that the nonwoven-fabric-type oil filter 100 according to an embodiment of the present invention is mounted thereto. The first cover member 10 is provided with first oil holes 13 for allowing oil flow therethrough. The first oil hole is planarly provided as a plurality (e.g., three), and they have equal planar spacing therebetween, and oil from the valve body 11 can flow therethrough. The second cover member 20 conjoins the first cover member 10.

The second cover member 20 is mounted to the first cover member 10, and both the first and second cover members 10 and 20 have a bolt-engagement hole 21, so they are bolt-engaged with the valve body 11 together. The second cover member 20 has one second oil hole 23 for allowing oil flow therethrough. A hollow portion is formed between the first and second cover members 10 and 20, and the nonwoven fabric oil filter 30 is mounted in the hollow portion.

The nonwoven fabric oil filter 30 filters oil that flows from the open side of the valve body 11. The nonwoven fabric oil filter 30 increases in volume during its filtering operation, and the hollow portion between the first and second cover members 10 and 20 allows room for such an increase in volume during the filtering.

Since the nonwoven fabric oil filter 30 is inserted between the first and second cover members 10 and 20, and they closely contact the open side of the valve body 11, the limitation of mounting volume is alleviated, and filtering efficiency and durability are enhanced.

Reference number 25 denotes a gasket that is interposed between the first cover member 10 and the valve body 11 such that oil leakage therefrom is prevented.

A nonwoven-fabric-type oil filter integral to a valve body according an embodiment of the present invention has the following effects.

Since oil is filtered by the nonwoven-fabric-type oil filter inserted between first and second cover members that closely contact an open side of the valve body, filtering efficiency and durability are enhanced.

In addition, since the oil filter is integrated with the valve body, the degree of freedom in designing is enhanced.

While this invention has been described in connection with an embodiment as shown in drawings, it is to be understood that the invention is not limited to the disclosed embodiments, but, on the contrary, is intended to cover various modifications and equivalent arrangements included within the spirit and scope of the appended claims.

1. A nonwoven-fabric-type oil filter integral to a valve body, comprising:
a first cover member mounted to an open side of the valve body, the first cover member having at least one first oil hole for allowing oil flow therethrough, the first cover member being in close contact with the valve body;
a second cover member conjoined with the first cover member, the second cover member having at least one second oil hole; and
a nonwoven fabric oil filter disposed in a hollow portion between the first and second cover members, for filtering oil flowing from the valve body into the hollow portion.

2. The nonwoven-fabric-type oil filter of claim 1, wherein a plurality of the first oil holes are provided.

3. The nonwoven-fabric-type oil filter of claim 1, wherein a gasket is interposed between the first cover member and the valve body such that oil leakage therefrom is prevented.

4. The nonwoven-fabric-type oil filter of claim 1, wherein the first and second cover members are bolt-engaged to the valve body.

5. The nonwoven-fabric-type oil filter of claim 1, wherein:
at least three first oil holes are provided, with equal planar spacing;
a gasket is interposed between the first cover member and the valve body such that oil leakage therefrom is prevented; and
the first and second cover members are bolt-engaged to the valve body.

6. A nonwoven-fabric-type oil filter, comprising:
a first cover member configured and dimensioned to be mounted in close contact with an open side of a valve body, the first cover member having at least one first oil hole for allowing oil flow therethrough;
a second cover member conjoined with the first cover member and defining a hollow therebetween, the second cover member having at least one second oil hole;
a nonwoven fabric oil filter disposed in said hollow between the first and second cover members, for filtering oil flowing from the valve body into the hollow portion; and
a gasket disposed against said first cover member and configured and dimensioned to be interposed between said first cover member and the valve body such that oil leakage therefrom is prevented.

7. The nonwoven-fabric-type oil filter of claim 6, wherein a plurality of the first oil holes are provided.

8. The nonwoven-fabric-type oil filter of claim 7, wherein at least three first oil holes are provided, with equal planar spacing.
